(19) United States
(12) Patent Application Publication
(10) Pub. No.: US 2009/0295739 A1
(43) Pub. Date: Dec. 3, 2009

(54) HAPTIC TACTILE PRECISION SELECTION

(76) Inventor: Wes Albert Nagara, Commerce Twp, MI (US)

Correspondence Address: FRASER CLEMENS MARTIN & MILLER LLC, 28366 KENSINGTON LANE, PERRYSBURG, OH, 43551, US

(21) Appl. No.: 12/127,337

(22) Filed: May 27, 2008

(51) Int. Cl. G06F 3/041

(52) U.S. Cl. 345/173

(57) ABSTRACT

A feedback control system and a method for controlling a tactile feedback are disclosed, wherein the feedback control system provides users with full precise control of infinite tactile feedback settings. The tactile feedback control system includes a user interface adapted to generate and transmit an information signal including data and information representing a user-provided input, wherein the user interface also generates a tactile sensation to the user, a controller adapted to receive the information signal, analyze the information signal, and generate and transmit a control signal for controlling a tactile feedback in response to the information signal, and a haptic system adapted to receive the control signal and generate the tactile feedback.

### FIELD OF THE INVENTION

The present invention relates to haptics. More particularly, the invention is directed to a feedback control system and a method for controlling a tactile feedback.

### BACKGROUND OF THE INVENTION

Currently, in Human Machine Interface (HMI), haptic tactile feedback sensitivity settings are limited to a predetermined number of presets. Each preset is programmed with a specific tactile feedback force, amplitude, and frequency. Once haptic products are programmed at the factory with the feedback presets, the end-user is limited to the pre-programmed feedback and is not able to directly change any undesirable presets. Typically, the only way to reprogram the haptic products is to return the products to the manufacturing location. Further, there is the possibility that the haptic products will be programmed with incorrect tactile feedback forces. If a large number of consumers complain about the predetermined forces, a team would have to be assembled to quickly address such concerns. This not only tarnishes the company's reputation, but also costs time and money. Also, much time and cost for various HMI studies are usually required to determine these presets.

In summary, tactile feedback forces generated by haptic products are typically pre-defined, pre-determined, and pre-programmed by the manufacturer prior to the end users' interaction. This leads to risks such as incorrect programming, choice limitation, and an undesirable tactile feedback for some consumers.

It would be desirable to have a tactile feedback control system and a method for controlling a tactile feedback, wherein the feedback control system provides users with full precise control of the infinite tactile feedback settings.

### SUMMARY OF THE INVENTION

Concordant and consistent with the present invention, a feedback control system and a method for controlling a tactile feedback, wherein the feedback control system provides users with full precise control of the infinite tactile feedback settings, has surprisingly been discovered.

In one embodiment, a tactile feedback control system comprises a user interface adapted to generate and transmit an information signal including data and information representing a user-provided input, wherein the user interface also generates a tactile sensation to the user, and a controller adapted to receive the information signal, analyze the information signal, and generate and transmit a control signal for controlling a tactile feedback in response to the information signal.

In another embodiment, a tactile feedback control system comprises a user interface adapted to generate and transmit an information signal including data and information representing a user-provided input, wherein the user interface also generates a tactile sensation to the user, a controller adapted to receive the information signal, analyze the information signal, and generate and transmit a control signal for controlling a tactile feedback in response to the information signal, and a haptic system adapted to receive the control signal and generate the tactile feedback.

The invention also provides methods for controlling a tactile feedback.

One method comprises the steps of: receiving at least one user-provided input; generating an information signal including data and information representing the at least one user-provided input; analyzing the information signal; generating a control signal in response to the analysis of the information signal; and generating a tactile feedback to a user in response to the control signal.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a schematic block diagram of a feedback control system according to an embodiment of the present invention; and

FIG. 2 is a front elevational view of a user interface of the feedback control system illustrated in FIG. 1.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

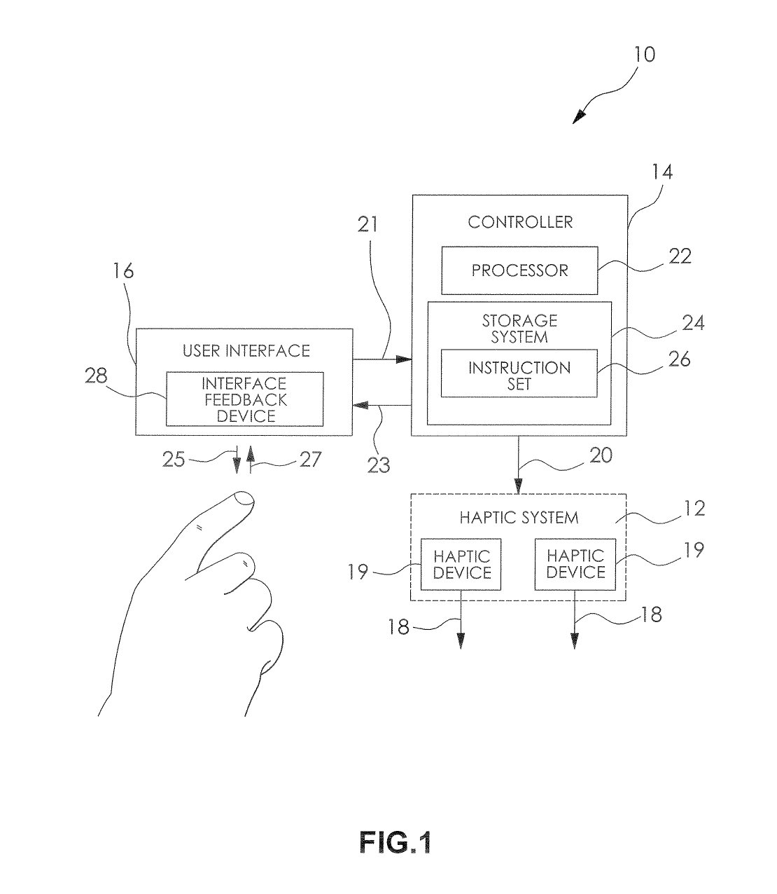

FIG. 1 shows a tactile feedback control system 10 according to an embodiment of the present invention. As shown, the tactile feedback control system 10 includes a haptic system 12, a controller 14, and a user interface 16.

The haptic system 12 is adapted to generate a tactile feedback 18 to a user. As shown, the haptic system 12 includes a pair of haptic devices 19, each haptic device 19 adapted to produce a tactile feedback 18 to the user. However, any number of the haptic devices 19 may be included, as desired. As a non-limiting example, each of the haptic devices 19 may be a haptic generator integrated with at least one of a vehicle surface, a steering wheel, a touch screen, a shifter, a control button, and a rotary knob. Other surfaces and devices may be adapted to produce the tactile feedback 18, as desired. It is further understood that the tactile feedback 18 generated by each of the haptic devices 19 of the haptic system 12 may include a variable frequency, a variable amplitude, and a variable pulse pattern, for example. Other dynamic tactile feedback 18 sensations may be provided to the user by the haptic system 12, as desired. As a non-limiting example, the haptic system 12 may be installed in a vehicle during a manufacturing process of the vehicle. It is further understood that the haptic system 12 may be installed in the vehicle by a post-production process. As shown, the haptic system 12 is in communication with the controller 14. As such, the haptic system 12 is adapted to receive a control signal 20 from the controller 14 for managing, regulating and controlling the tactile feedback 18 generated by the haptic devices 19 of the haptic system 12.

The controller 14 is adapted to receive an information signal 21, analyze the information signal 21, and transmit a control signal 20 to the haptic system 12 in response to the analysis of the information signal 21. The information signal 21 represents a user-provided input 27 for modifying the tactile feedback 18 generated by the haptic system 12. Specifically, the information signal 21 may include data and information related to a desired tactile feedback 18 to be generated by the haptic system 12. The controller 14 is further adapted to transmit an interface feedback control signal 23 to the user interface 16. The interface feedback control signal 23 includes information and data that is received by the user interface 16 for controlling a tactile sensation 25 of the user interface 16. The controller 14 may be any device adapted to receive the information signal 21, analyze the vehicle information signal 21, and transmit the control signal 20 and the interface feedback control signal 23 such as a microcomputer, for example. Other devices may be used, as appropriate. It is understood that the analysis of the information signal 21 by the controller 14 may be pre-determined. It is further understood that the analysis of the information signal 21 may by modified, as desired. In certain embodiments the controller 14 may be adapted to provide individual control of the tactile feedback 18 of a particular haptic device 19. For example, the controller 14 may include individualized control signals 20 for selectively controlling the tactile feedback 18 of each haptic device 19 of the haptic system 12.

In certain embodiments, the controller 14 includes a processor 22 and a storage system 24. The processor 22 is adapted to analyze the information signal 21 based upon an instruction set 26. The instruction set 26, which may be embodied within any computer readable medium, includes processor executable instructions for configuring the processor 22 to perform a variety of tasks. As a non-limiting example, the processor 22 may be adapted to generate and transmit the control signal 20 and the interface feedback control signal 23 in response to the analysis of the information signal 21. The storage system 24 may be a single storage device or may be multiple storage devices. Portions of the storage system 24 may also be located on the processor 22. Furthermore, the storage system 24 may be a solid state storage system, a magnetic storage system, an optical storage system or any other suitable storage system. It is understood that the storage system 24 is adapted to store the instruction set 26. Other data and information may be stored in the storage system 24, as desired. As a non-limiting example, user-defined presets may be stored on and retrieved from the storage system 24.

The user interface 16 is in communication with the controller 14 and adapted to transmit the information signal 21 to the controller 14 in response to the user-provided input 27. The user interface 16 is also adapted to receive the interface feedback control signal 23 for controlling the tactile sensation 25 of the user interface 16. The user interface 16 includes an interface feedback device 28 adapted to generate and transmit the tactile sensation 25 directly to the user as the user engages the user interface 16. For example, where the user is in contact with the user interface 16, the interface feedback device 28 of the user interface 16 generates a vibratory sensation to the user's hand. It is understood that the interface feedback device 28 may be adapted to directly receive the interface feedback control signal 23 for controlling the tactile sensation 25. It is further understood that the user interface 16 may include an internal processor (not shown) for directly receiving at least one of the user provided input 27 and the interface feedback control signal 23 for controlling the interface feedback device 28.

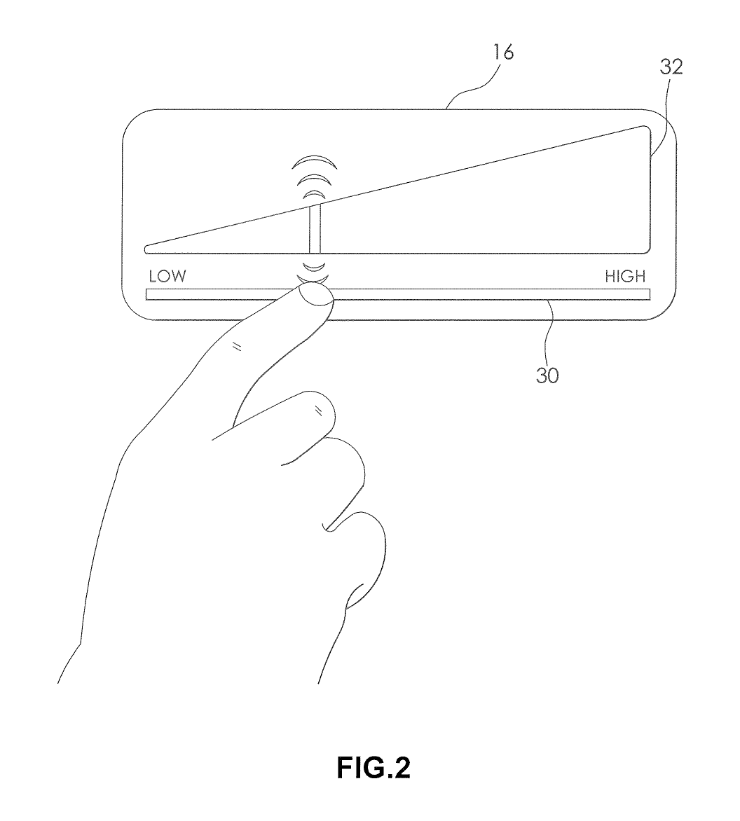

In one embodiment, shown in FIG. 2, the user interface 16 is a touch screen window slider. Specifically, the user interface 16 is a touch sensitive screen having a slider 30, an audio output (not shown), and a display 32. As the user moves his/her finger across the slider 30, the tactile sensation 25 of the user interface 16 varies in response to the slider 30 motion.

Referring to FIGS. 1 and 2, for example, the tactile sensation 25 generated by the interface feedback device 28 may increase in one direction of the slider 30 motion and decrease in the other direction. The variation of the generated tactile sensation 25 may be modified, as desired. As the slider 30 moves, the tactile sensation 25 varies and the user interface 16 transmits new information and data to the controller 14 through the information signal 21. As a non-limiting example, the information signal 21 represents the user-provided input 27, wherein the user-provided input 27 is embodied by the slider 30 motion.

In use, the user engages the user interface 16. In certain embodiments, as shown in FIG. 2, the user may “slide” his/her finger across the slider 30 of the user interface 16. Other user interfaces 16 may be used such as a touch screen having dedicated increase and decrease buttons and a rotary knob, for example. Once the user engages the user interface 16, the information signal 21 is generated and transmitted to the controller 14. The controller 14 receives the information signal 21, analyzes the information signal 21, and generates the control signal 20 in response to the analysis of the information signal 21. The control signal 20 is received by the haptic system 12 for managing, regulating and controlling the tactile feedback 18 generated by the haptic devices 19 of the haptic system 12. It is understood that the controller may also generate the interface feedback control signal 23 in response to the analysis of the information signal 21. The interface feedback control signal 23 is received by the interface feedback device 28 for managing, regulating and controlling the tactile sensation 25 of the user interface 16. It is understood that the tactile sensation 25 of the user interface 16 is consistent with the tactile feedback 18 generated by the haptic system 12. For example, the tactile sensation 25 that a user feels on the user interface 16 is substantially the same sensation of the tactile feedback 18 generated by the haptic devices 19 of the haptic system 12. As the user provides the user-provided input 27 to the user interface 16, and thereby modifies the tactile feedback 18 generated by the haptic system 12, the tactile sensation 25 of the user interface 16 is adjusted in real-time and transmitted to the user. Therefore, the user has control of the desired “feeling” they would like to receive from the haptic devices 19 of the haptic system 12 by the real-time interface feedback transmitted from the user interface 16 in the form of the tactile sensation 25. As a non-limiting example, where the user-provided input 27 represents an increase in the amplitude of the desired tactile feedback 18, the information signal 21 transmitted to the controller 14 also represents the desired increase in amplitude and the controller 14 therefore increases the amplitude of the tactile feedback 18 of the haptic system 12. Simultaneously, the amplitude of the tactile sensation 25 of the user interface 16 increases to mirror the tactile feedback 18 generated by the haptic system 12. It is understood that the user interface 16 may be adapted to provide individual control of the tactile feedback 18 of a particular haptic device 19. For example, the user interface 16 may include a menu function, wherein the user may selectively control the tactile feedback 18 of each haptic device 19 of the haptic system 12.

The feedback control system 10 provides the user the ability to easily program and vary infinitely the tactile feedback 18 generated by the haptic system 12 using various user interfaces 16, such as a window slider, shown in FIG. 2. The feedback control system 10 and the method for controlling the tactile feedback 18 addresses and substantially eliminates the concerns and limitations of the predetermined and preset haptic technology currently manufactured. Now, the control is in the users' hands rather than preprogrammed by the manufacturer. The feedback control system 10 provides greater flexibility for both the users and the manufacturer. All the HMI studies and associated costs required to predetermine the forces can be eliminated.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A tactile feedback control system comprising:
a user interface adapted to generate and transmit an information signal including data and information representing a user-provided input, wherein the user interface also generates a tactile sensation to the user; and
a controller adapted to receive the information signal, analyze the information signal, and generate and transmit a control signal for controlling a tactile feedback in response to the information signal.

2. The tactile feedback control system according to claim 1, further comprising a haptic system adapted to receive the control signal and generate the tactile feedback in at least one of a plurality of haptic devices.

3. The tactile feedback control system according to claim 2, wherein the user interface provides individual and selective control of at least one of the haptic devices.

4. The tactile feedback control system according to claim 1, wherein the controller generates an interface feedback control signal for controlling the tactile sensation of the user interface in response to the information signal.

5. The tactile feedback control system according to claim 1, wherein the tactile sensation of the user interface is substantially similar to the tactile feedback.

6. The tactile feedback control system according to claim 1, wherein the user interface is a touch screen slider window.

7. The tactile feedback control system according to claim 1, wherein the controller includes a processor adapted to analyze the information signal.

8. The tactile feedback control system according to claim 7, wherein the controller includes an instruction set having processor executable instructions for configuring the processor to perform the analysis of the information signal.

9. The tactile feedback control system according to claim 1, wherein the controller includes a storage system for storing data and information.

10. A tactile feedback control system comprising:
a user interface adapted to generate and transmit an information signal including data and information representing a user-provided input, wherein the user interface also generates a tactile sensation to the user;
a controller adapted to receive the information signal, analyze the information signal, and generate and transmit a control signal for controlling a tactile feedback in response to the information signal; and
a haptic system adapted to receive the control signal and generate the tactile feedback.

11. The tactile feedback control system according to claim 10, wherein the haptic system generates the tactile feedback in at least one of a plurality of haptic devices.

12. The tactile feedback control system according to claim 11, wherein the user interface provides individual and selective control of at least one of the haptic devices.

13. The tactile feedback control system according to claim 10, wherein the controller generates an interface feedback control signal for controlling the tactile sensation of the user interface in response to the information signal.

14. The tactile feedback control system according to claim 10, wherein the tactile sensation of the user interface is substantially similar to the tactile feedback.

15. The tactile feedback control system according to claim 10, wherein the user interface is a touch screen slider window.

16. A method for controlling a tactile feedback, the method comprising the steps of:
receiving at least one user-provided input;
generating an information signal including data and information representing the at least one user-provided input;
analyzing the information signal;
generating a control signal in response to the analysis of the information signal; and
generating a tactile feedback to a user in response to the control signal.

17. The method according to claim 16, wherein the information signal is generated by a user interface adapted to receive the user-provided input.

18. The method according to claim 17, wherein the user interface is adapted to generate a tactile sensation in response to the user-provided input.

19. The method according to claim 18, wherein the tactile sensation generated by the user interface is substantially similar to the tactile feedback.

20. The method according to claim 16, wherein the tactile feedback is generated by a haptic system adapted to receive the control signal.
